(19) United States
(12) Patent Application Publication
(10) Pub. No.: US 2010/0175600 A1
(43) Pub. Date: Jul. 15, 2010

(54) Liquid Furrowing Device for Seeding Implement

(76) Inventor: Brian Cruson, Chilliwack (CA)

Correspondence Address: ADE & COMPANY INC., 2157 Henderson Highway, WINNIPEG, MB, R2G1P9, CA

(21) Appl. No.: 12/687,418

(22) Filed: Jan. 14, 2010

Related U.S. Application Data
(60) Provisional application No. 61/144,932, filed on Jan. 15, 2009.

(51) Int. Cl. A01C 5/06; B05B 1/00

(52) U.S. Cl. 111/149; 222/566

(57) ABSTRACT

An agricultural seeding implement comprises a plurality of furrowing devices independently supported by respective suspension members on a frame for movement together with the frame in a forward working direction. A pressurizing system is arranged to provide a flow of fluid under pressure from a source of liquid associated with the frame to a fluid nozzle assembly of each furrowing device. In a preferred embodiment, each fluid nozzle assembly comprises two furrowing nozzles oriented to direct the respective flow of fluid under pressure downwardly towards the ground to form a common furrow in the ground associated with the fluid nozzle assembly. A seed tube is supported rearwardly of each furrowing device so as to be arranged to deposit seed in the furrow formed by the furrowing device.

This application claims the benefit under 35 U.S.C. 119(e) of U.S. provisional application Ser. No. 61/144,932, filed Jan. 15, 2009.

### FIELD OF THE INVENTION

The present invention relates to a liquid furrowing device for forming a furrow in the ground using high pressure jets of liquid, and more particularly relates to a seeding implement for forming a plurality of furrows using liquid furrowing devices and for depositing seeds in the liquid formed furrows.

### BACKGROUND

In order to preserve soil moisture, a minimum disturbance of the soil is desirable when planting seed or injecting fertilizer into the soil. Various examples of placing seed or fertilizer using a high pressure jet of fluid are known in the prior art.

U.S. Pat. No. 5,605,105 by Clark et al. and U.S. Pat. No. 5,101,745 by Podevels et al. disclose examples of planting devices in which seed is carried by a high pressure jet of fluid into the ground for planting. Mixing the seed with the injected fluid however makes it difficult to meter the amount of seed being deposited in the ground while also causing potential damage to the seed by the high impact of the fluid injecting the seed into the ground.

U.S. Pat. No. 4,300,461 by Hodge et al. discloses an example of a grass seed planter in which fluid nozzles form openings in the ground into which seed is subsequently deposited. The fluid injector nozzles and the seed tubes are all fixed together on a small common frame suitable for small scale use on level ground. The fixed relationship of the components on a small frame cannot be readily adapted to a large scale agricultural application with varying ground contours.

U.S. Pat. No. 4,186,671 by Huang discloses an example of a planter using fluid nozzles for forming openings in the ground into which plants are deposited. The nozzles are similarly fixed in relationship to the frame upon which they are carried which is in turn fixed to the plant conveying equipment for placing plants in the holes formed in the ground so that the device is not suitable for forming openings in the ground of accurate depth at each location in a large scale agricultural application in which the contour of the ground varies.

### SUMMARY OF THE INVENTION

According to one aspect of the invention there is provided an agricultural seeding implement comprising:

a frame supported for movement across the ground in a forward working direction;

a plurality of furrowing devices supported on the frame for movement together with the frame in the forward working direction, each furrowing device comprising a fluid nozzle assembly;

a plurality of suspension members supporting the furrowing devices on the frame such that at least some of the furrowing devices are supported for movement relative to the frame independently of one another;

a source of liquid arranged to be associated with the frame for movement together with the frame in the forward working direction;

a pressurizing system arranged to provide a flow of fluid under pressure from the source of liquid to each of the fluid nozzle assemblies;

each fluid nozzle assembly being oriented to direct the respective flow of fluid under pressure from the pressurizing system downwardly towards the ground so as to be arranged to form a furrow in the ground in the forward working direction;

a seed supply associated with the frame for movement together with the frame in the forward working direction;

a seed tube supported rearwardly of each furrowing device so as to be arranged to deposit seed in the furrow formed by the furrowing device; and

a seed deliver system arranged to deliver seed from the seed supply to each of the seed tubes.

By providing a combination of a plurality of fluid nozzle furrowing devices supported for movement relative to the frame independently of one another with seed tubes associated therewith, a plurality of furrows of accurate depth relative to one another despite varying ground contours can be achieved. Accordingly the furrowing devices according to the present invention are well suited for large scale agricultural seed planting without the use of tillage equipment to minimize soil disturbance and therefore minimize loss of soil moisture.

Each furrowing device may be supported by a respective one of the suspension members on the frame such that each furrowing device is supported for independent movement relative to the frame.

Each suspension member may comprise a swing arm and a pivot which pivotally couples the swing arm to the frame, the furrowing devices being supported on the swing arms spaced rearwardly of the respective pivots.

Each fluid nozzle assembly may be supported such that a height of the fluid nozzle assembly is adjustable relative to the respective swing arm.

When there is provided a ground follower associated with each suspension member and arranged to follow a contour of the ground, the furrowing devices may be movable together with the respective ground followers relative to the frame.

Each ground follower may comprise a packer wheel supported rearwardly of the respective seed tube so as to be arranged to close the respective furrow.

When each suspension member comprises a swing arm and a pivot which pivotally couples the swing arm to the frame, the furrowing devices are preferably supported on the swing arms spaced rearwardly of the respective pivots while the packer wheels are preferably supported on the respective swing arms for movement together with the respective furrowing devices and the respective swing arms relative to the frame.

Each nozzle assembly may comprise a pair of furrowing nozzles spaced apart from one another in a lateral direction oriented transversely to the forward working direction in which each furrowing nozzle is oriented to direct a respective high pressure jet of fluid downwardly and inwardly towards the other furrowing nozzle of the nozzle assembly.

When there is provided a ground follower associated with each suspension member so as to be arranged to follow a contour of the ground and the furrowing devices are movable together with the respective ground followers relative to the frame, the furrowing nozzles may be oriented such that the high pressure jets of the furrowing nozzles of each nozzle assembly are arranged to intersect one another at a location spaced below the ground follower corresponding to a bottom of the respective furrow.

Each nozzle assembly may further comprise a lead nozzle oriented to direct a respective high pressure jet of fluid downwardly and forwardly into the forward working direction. When each nozzle assembly comprises at least one furrowing nozzle, the furrowing nozzle is preferably oriented to direct a respective high pressure jet downwardly towards the ground, rearwardly of the high pressure jet from the lead nozzle such that said at least one furrowing nozzle is arranged to form the respective furrow in the ground.

There may be provided an upright guard member supported on a respective one of the suspension members forwardly of each furrowing device in which the guard member extends downwardly towards the ground to a bottom end positioned lower in elevation than the respective furrowing device. The nozzle assembly of each furrowing device may be supported for adjustment in height relative to the respective guard member.

There may also be provided a pair of furrow closing members associated with each furrowing device in which the furrow closing members are spaced apart in a lateral direction oriented transversely to the forward working direction on opposing sides of the respective nozzle assembly to extend rearward and inwardly towards one another to respective trailing ends positioned rearwardly of the respective nozzle assembly. The packer wheel may be supported rearwardly of the trailing ends of the respective pair of furrow closing members.

When the frame comprises an agricultural drawbar arranged for towing connection to a tractor, each furrowing device may be releasably supported on the drawbar.

There may be provided a residue manager device supported forwardly of each furrowing device which is arranged to clear loose material above the ground in front of the respective furrowing device.

According to a second aspect of the present invention there is provided an agricultural seeding implement comprising:

a frame supported for movement across the ground in a forward working direction;

a plurality of furrowing devices supported on the frame for movement together with the frame in the forward working direction, each furrowing device comprising a fluid nozzle assembly;

a source of liquid arranged to be associated with the frame for movement together with the frame in the forward working direction;

a pressurizing system arranged to provide a flow of fluid under pressure from the source of liquid to each of the fluid nozzle assemblies;

each fluid nozzle assembly comprising two furrowing nozzles oriented to direct the respective flow of fluid under pressure from the pressurizing system downwardly towards the ground such that the two furrowing nozzles are arranged to commonly form a furrow in the ground associated with said fluid nozzle assembly;

a seed supply associated with the frame for movement together with the frame in the forward working direction;

a seed tube supported rearwardly of each furrowing device so as to be arranged to deposit seed in the furrow formed by the furrowing device; and

a seed deliver system arranged to deliver seed from the seed supply to each of the seed tubes.

The two furrowing nozzles of each nozzle assembly may be spaced apart from one another in a lateral direction oriented transversely to the forward working direction with each furrowing nozzle being oriented to direct a respective high pressure jet of fluid downwardly and inwardly towards the other furrowing nozzle of the nozzle assembly.

When there is provided a suspension member supporting each furrowing device on the frame and a ground follower associated with each suspension member which is arranged to follow a contour of the ground, and the furrowing devices are movable together with the respective ground followers relative to the frame, the furrowing nozzles are preferably oriented such that the high pressure jets of the furrowing nozzles of each nozzle assembly are arranged to intersect one another at a location spaced below the ground follower corresponding to a bottom of the respective furrow.

Each nozzle assembly may further comprise a lead nozzle oriented to direct a respective high pressure jet of fluid downwardly and forwardly into the forward working direction ahead of the two furrowing nozzles of the nozzle assembly.

Some embodiments of the invention will now be described in conjunction with the accompanying drawings in which:

### BRIEF DESCRIPTION OF THE DRAWINGS

FIG. 1 is a perspective view of a first embodiment of the furrowing device according to the present invention.

FIG. 2 is a side elevational view of the furrowing device according to FIG. 1.

FIG. 3 and FIG. 4 are respective top plan and front elevational views of the device according to FIG. 1.

FIG. 5 is a perspective view of a front and bottom side of the device according to FIG. 1 shown with the guard removed.

FIG. 6 is a rear perspective view of the seed tube and the surrounding supporting structure shown separated from the swing arm in the device of FIG. 1.

FIG. 7 is a schematic representation of an agricultural seeding implement upon which plural furrowing devices are supported.

FIG. 8 is a perspective view of an alternative embodiment of the furrowing device.

In the drawings like characters of reference indicate corresponding parts in the different figures.

### DETAILED DESCRIPTION

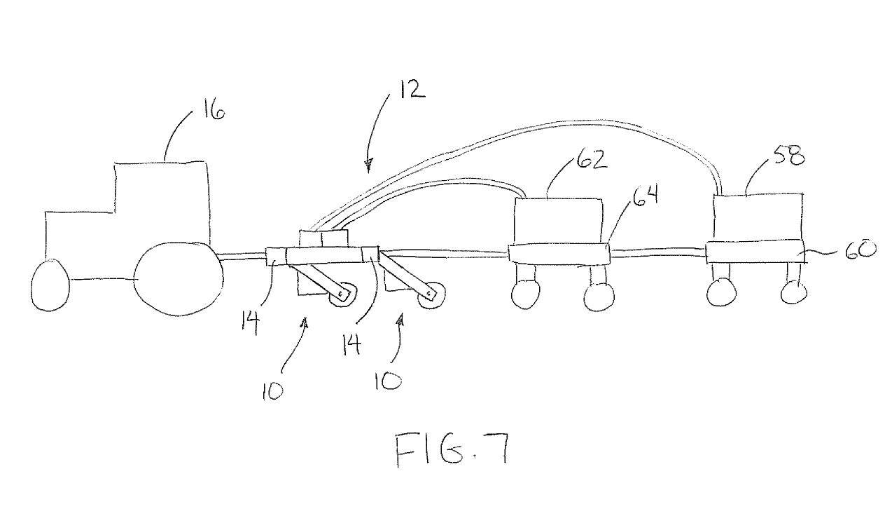

Referring to the accompanying figures there is illustrated a liquid furrowing device generally indicated by reference numeral 10. The device 10 is particularly suited for use on an agricultural seeding implement 12 of the type represented schematically in FIG. 7.

The seeding implement 12 typically comprises a drawbar in the form of a horizontal beam 14 defining a frame which is supported for movement across the ground by connection to a towing tractor 16 which displaces the frame in a forward working direction. The beam is oriented generally perpendicularly to the forward working direction to extend in a lateral direction. A plurality of the furrowing devices 10 are supported at laterally spaced positions along the drawbar in a manner which permits the devices to be readily releasable from the drawbar. The devices 10 are suitably arranged for forming a plurality of parallel furrows in the ground which extend in the longitudinal forward working direction.

Each liquid furrowing device 10 generally comprises a drawbar mount 18 at a forward end thereof. The drawbar mount comprises a horizontal mounting plate 20 arranged to be secured at a forward end to the underside of the drawbar by a pair of U-shaped clamping bolts 22 which extend about the beam for securement to the plate at opposing ends thereof.

A swing arm 24 is pivotally supported to the mounting plate 20 of the drawbar mount at a position spaced rearwardly of the drawbar beam 14. The swing arm is pivotally supported on a horizontal pivot shaft 26 mounted on the mounting plate 20 such that the swing arm is pivotal about the pivot shaft 26 to define a horizontal pivot axis of the swing arm relative to the frame which is oriented in the lateral direction.

The swing arm 24 comprises two side members 28 supported at opposing ends of the pivot shaft so as to be parallel to one another and spaced apart in the lateral direction for pivotal movement together relative to the frame. Both side members 28 extend generally rearwardly and downwardly to respective trailing ends 30 spaced rearwardly of the drawbar mount. The two side members 28 are joined with one another by a front mounting plate 32 spanning generally horizontally between the two side members above the mounting plate 20 of the drawbar mount so as to be generally parallel thereto. Suspension is provided to the swing arm by a spring 34 acting between the front plate 32 and the top end of a post 36 which extends downwardly through the spring 34 and though a cooperating aperture in the front plate 32 for fixed connection at a bottom end to the mounting plate 20 of the drawbar mount. Forces resulting from compression of the spring about a respective vertical axis thereof extending along the post 36 function to urge the swing arm downwardly relative to the frame for urging the trailing ends of the swing arm downwardly into the ground.

The two side members of each swing arm 24 are also joined by an intermediate plate 38 spanning between the two side members at an intermediate location spaced in between the pivot shaft at the front end and the trailing ends of the side members.

An upright mounting plate 40 is also mounted between the two side members to extend generally downwardly from the side members below the intermediate plate at a location spaced forwardly of the trailing ends of the side members for supporting a seed tube 42 and other components of the furrowing device 10 for movement with the swing arm 24 relative to the frame.

One of the two side members 28 of each swing arm extends rearwardly beyond the other for supporting a packer wheel 44 at the trailing end thereof which is rotatable about a respective packer wheel axis oriented horizontally and perpendicularly to the forward working direction. The packer wheel 44 functions as a ground follower which rolls along the ground and maintains the elevation of each swing arm at a consistent prescribed level relative to the ground independently of any of the other swing arms 24. The packer wheel 44 thus follows the contours of the ground to raise the trailing end of the swing arm relative to the frame against the action of the spring 34 to roll over raised portions of the ground. In this manner each swing arm comprises an independent suspension member for independently suspending a respective one of the furrowing devices relative to the frame and the ground over which the frame is displaced in the forward working direction. The packer wheel 44 also functions to close and pack the furrow of the furrowing device 10 for which the packer wheel is associated.

Each furrowing device 10 forms a respective furrow by a nozzle assembly 46 located ahead of the respective seed tube 42 associated therewith. An upright mounting member 48 is mounted on the swing arm for adjustment in height relative to the side members 28 thereof by providing a bracket fixed on the intermediate plate of the swing arm which includes a plurality of cooperating apertures 50 for cooperation with cooperating apertures 50 on the upright mounting member. Alignment of different ones of the cooperating apertures and subsequent fastening by a fastener received therethrough serves to fix the upright mounting member and nozzle assembly 46 thereon at one of numerous heights relative to the swing arm upon which it is supported.

Additional support is provided to the upright mounting member 48 by slidably receiving the mounting member vertically through an auxiliary support 52 on the upright plate 40 below the intermediate plate. The auxiliary support 52 and the intermediate plate 38 serve to support and anchor the upright mounting member at two vertically spaced positions. The upright mounting member is supported forwardly of the upright plate 40 and the seed tube supported thereon. The nozzle assembly 46 is supported on the front side of the upright mounting member at the bottom end thereof.

The nozzle assembly includes a lead nozzle 54 which is centered in the lateral direction with respect to the furrow formed by the furrowing device 10. The lead nozzle 54 is arranged to direct a high pressure jet of fluid therefrom downwardly into the forward working direction due to the orientation of the nozzle. The lead nozzle thus acts as a residue manager for clearing loose material on the ground away from the path of the furrow formation by following furrowing nozzles 56 of the nozzle assembly.

More particularly, each nozzle assembly includes two furrowing nozzles 56 which are spaced apart in the lateral direction from one another at a location which is rearward of the lead nozzle 54 and the high pressure jet of fluid from the lead nozzle. The two furrowing nozzles of each nozzle assembly are oriented to project downwardly and inwardly towards one another such that respective high pressure jets of fluid are directed from the two furrowing nozzles in a generally V-shaped pattern in a common plane lying perpendicular to the forward working direction. The high pressure jets of fluid from the two furrowing nozzles intersect one another at a selected depth of the furrow to be formed at a location spaced below the bottom of the packer wheel. The V-shaped pattern of the two furrowing nozzles serves to clear a corresponding generally V-shaped furrow formation in the ground into which the seed tube following the nozzle assembly is arranged to deposit seed.

Fluid is delivered to each of the nozzles of the nozzle assembly from a source of fluid typically in the form of a tank 58 of water which is supported either on the frame or on a trailing cart 60 as shown schematically in FIG. 7. A pressurizing system in the form of suitable pumps and the like are arranged to provide a continuous flow of fluid under pressure from the tank 58 through a manifold to each of the nozzle assemblies and to each nozzle of the respective nozzle assemblies. The continuous flow of fluid permits the nozzles to be continuously operated as the frame is displaced in the forward working direction to form a continuous furrow into which a plurality of seeds are sequentially deposited.

The seed tube 42 is supported on the rear side of the upright plate of the swing arm so as to be aligned with the lead nozzle and the furrow formed by the furrowing nozzles of the respective nozzle assembly. The seed tube of each furrowing device is connection to a seed supply, for example a tank 62 supported on the frame or on a trailing cart 64. A seed delivery system is in communication between the seed tank 62 and each seed tube for metering in appropriate amount of seed to each seed tube. The seed delivery system typically comprises a conventional air seeding system including a blower, a manifold, and suitable tubing for communicating the seed in a metered quantity to each seed tube.

Each device 10 further comprises two furrow closing members 66 anchored on the upright plate 38 between the side members on opposing sides of the respective seed tube centrally located therebetween. Each furrow closing member comprises an upright plate which extends rearwardly and downwardly from a forward end supported on the upright plate to a rear portion. The two rear portions of the furrow closing members extend rearwardly and inwardly towards one another to the trailing ends defining a lateral gap therebetween which is smaller than the width of the packer wheel in the lateral direction and which is aligned with the packer wheel. The furrow closing members 66 are spaced apart at the forward end thereof in the lateral direction by a spacing which is typically near or greater than the width in the lateral direction of the furrow being formed. The inward tapering rear portions have a bottom side which is substantially level with the bottom of the packer wheel to gather loose earth at the sides of the furrow and direct the loose earth inwardly into the furrow for covering the seed deposited by the seed tube positioned ahead of the furrow closing members. Once the closing members redirect earth into the furrow, the packer wheel ensures the loose earth is packed and the furrow is closed after the device 10 has passed.

The closing members 66 are supported on the upright plate on the swing arm by fasteners extending through co-operating apertures so as to permit a height of the closing members relative to the swing arm, the packer wheel and the nozzle assembly to be adjusted.

Each device 10 further comprises a guard member 68 comprising an upright plate member which is generally U-shaped in plan view so as to comprise a forward central portion forming a central apex and two side portions which extend rearwardly and outwardly from the central apex to two spaced apart rear ends 70 which are mounted onto the two side members of the swing arm respectively. Accordingly the guard member 68 is moveable together with the swing arm, packer, two furrow closing members, and the nozzle assembly for pivotal movement relative to the frame independently of the other furrowing devices 10. Similarly adjustment of the height of the nozzle assembly relative to the swing arm also adjust elevation of the nozzle assembly relative to the guard member, furrow closing members, and packer wheel supported on the swing arm.

The guard member 68 surrounds the nozzle assembly along laterally opposed sides and forwardly therefrom from an upper edge above the nozzle assembly to a lower edge below the nozzle assembly and near elevation of the bottom of the furrow closing members and the packer wheel. The bottom edge of the guard member is spaced slightly upward from the bottom of the packer wheel so as to be free of engagement with the ground while ensuring that the swing arm is deflected upwardly and the nozzle assembly is protected in the event of contact with any debris or obstacle on the ground.

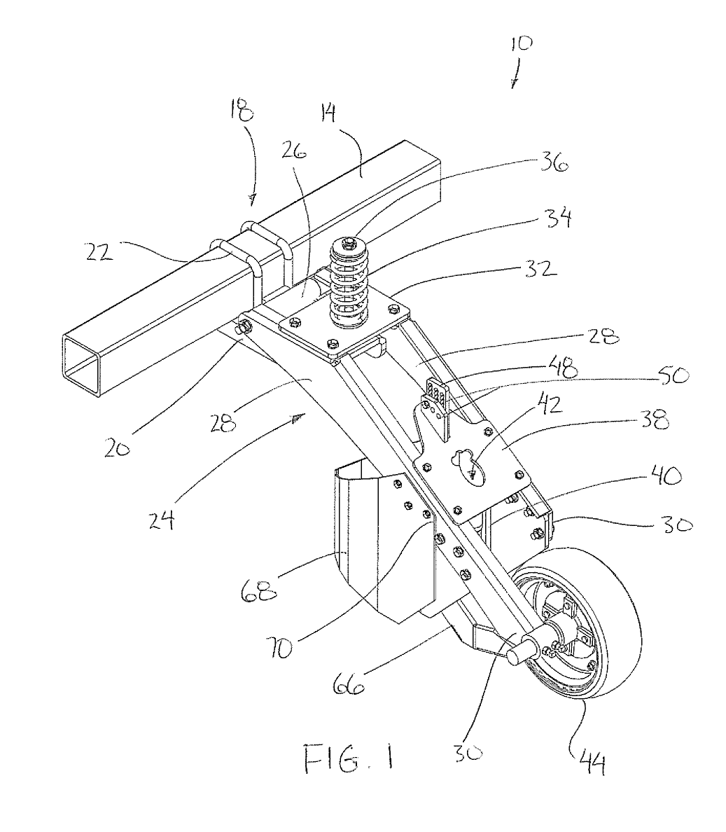

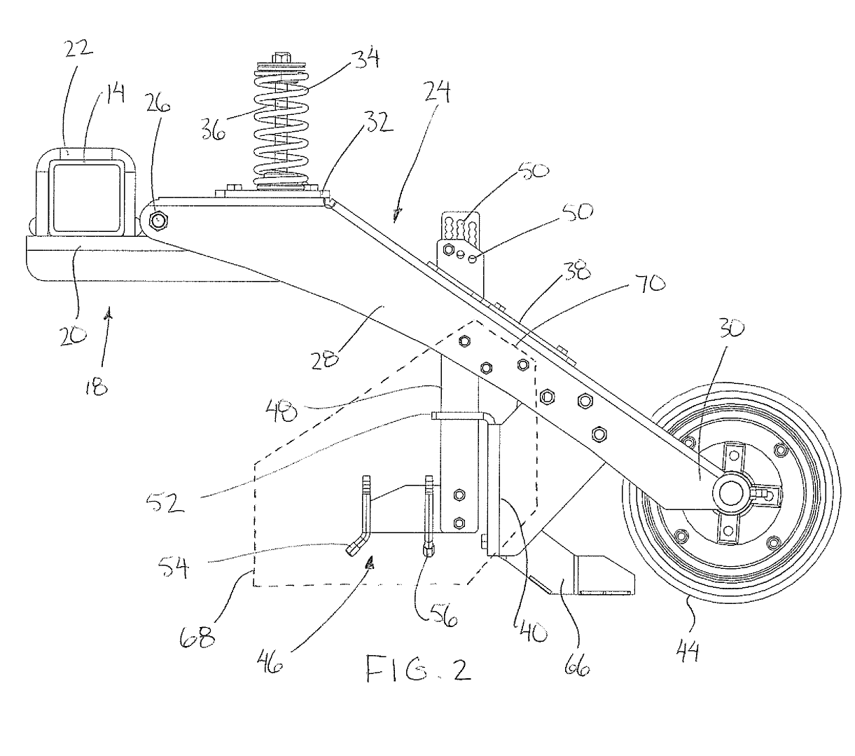

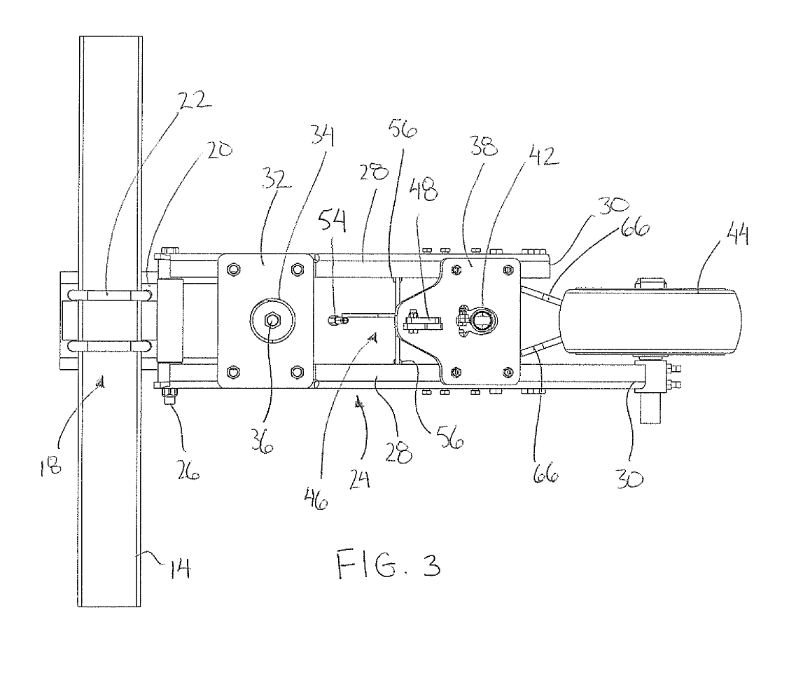

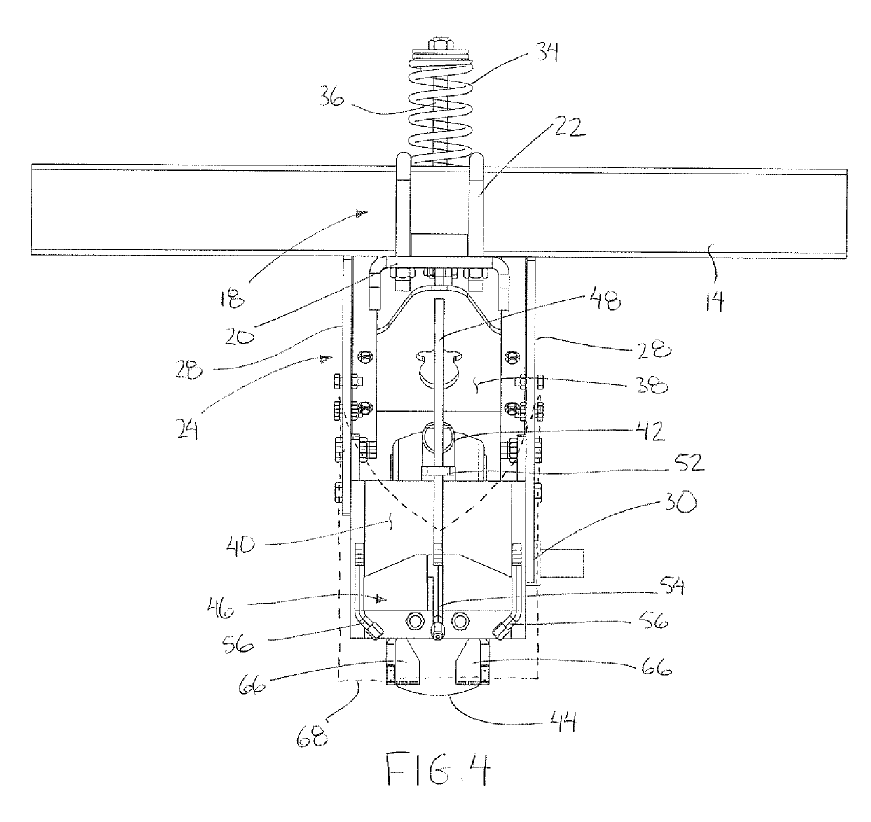

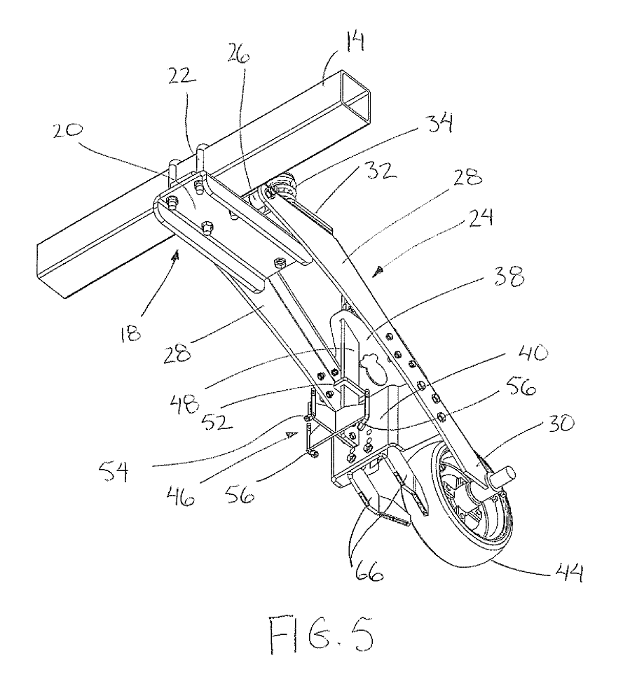

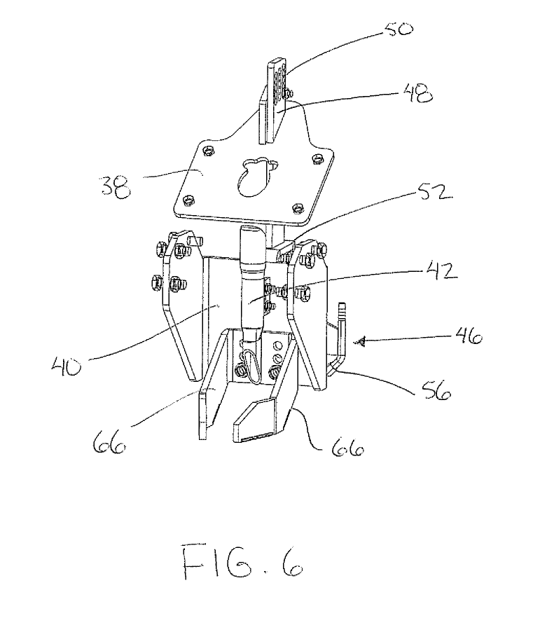

As shown in the first embodiment of FIG. 1 through 7, the seed tube 42 is provided with an open bottom end in which the plane of the opening extends upward at a rearward incline so that the opening faces partly rearward to prevent plugging with dirt or debris.

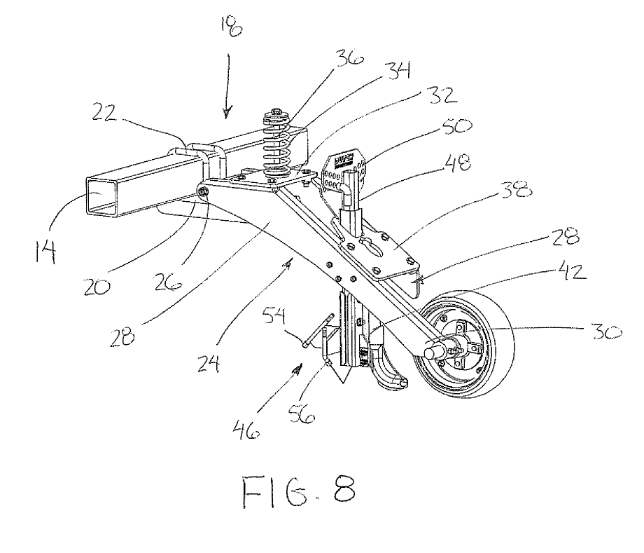

In the alternative embodiment of FIG. 8, the seed tube may include a lower portion which is curved downwardly and rearwardly such that the opening of the seed tube is located substantially in a vertical plane and the seed tube directs seed rearwardly towards the packer wheel. As further shown in the embodiment of FIG. 8, various mounting members may be provided on the swing arm for supporting the seed tube and nozzle assembly thereon, however in each instance the nozzle assembly is permitted to be displaced pivotally with the swing arm relative to the implement frame such that the nozzle assemblies are supported for independent suspension relative to one another to ensure each nozzle assembly is located at a precise space above the ground for optimal furrow formation.

In further embodiments, the orientation and configuration of the nozzles may be altered depending upon the size and desired characteristics of the furrow being formed.

In yet further embodiments a mechanical device may be provided ahead of the nozzle assembly for engagement with the ground to clear loose material or debris from the surface of the ground in addition to or in place of the lead nozzle to ensure that the furrowing nozzles are permitted to penetrate the ground with the respective high pressured jets of fluid therefrom.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An agricultural seeding implement comprising:
a frame supported for movement across the ground in a forward working direction;
a plurality of furrowing devices supported on the frame for movement together with the frame in the forward working direction, each furrowing device comprising a fluid nozzle assembly;
a plurality of suspension members supporting the furrowing devices on the frame such that at least some of the furrowing devices are supported for movement relative to the frame independently of one another;
a source of liquid arranged to be associated with the frame for movement together with the frame in the forward working direction;
a pressurizing system arranged to provide a flow of fluid under pressure from the source of liquid to each of the fluid nozzle assemblies;
each fluid nozzle assembly being oriented to direct the respective flow of fluid under pressure from the pressurizing system downwardly towards the ground so as to be arranged to form a furrow in the ground in the forward working direction;
a seed supply associated with the frame for movement together with the frame in the forward working direction;
a seed tube supported rearwardly of each furrowing device so as to be arranged to deposit seed in the furrow formed by the furrowing device; and
a seed deliver system arranged to deliver seed from the seed supply to each of the seed tubes.

2. The implement according to claim 1 wherein each furrowing device is supported by a respective one of the suspension members on the frame such that each furrowing device is supported for independent movement relative to the frame.

3. The implement according to claim 1 wherein each suspension member comprises a swing arm and a pivot which pivotally couples the swing arm to the frame, the furrowing devices being supported on the swing arms spaced rearwardly of the respective pivots.

4. The implement according to claim 3 wherein each fluid nozzle assembly is supported such that a height of the fluid nozzle assembly is adjustable relative to the respective swing arm.

5. The implement according to claim 1 wherein there is provided a ground follower associated with each suspension member and arranged to follow a contour of the ground, the furrowing devices being movable together with the respective ground followers relative to the frame.

6. The implement according to claim 5 wherein each ground follower comprises a packer wheel supported rearwardly of the respective seed tube so as to be arranged to close the respective furrow.

7. The implement according to claim 6 wherein each suspension member comprises a swing arm and a pivot which pivotally couples the swing arm to the frame, the furrowing devices being supported on the swing arms spaced rearwardly of the respective pivots and the packer wheels being supported on the respective swing arms for movement together with the respective furrowing devices and the respective swing arms relative to the frame.

8. The implement according to claim 1 wherein each nozzle assembly comprises a pair of furrowing nozzles spaced apart from one another in a lateral direction oriented transversely to the forward working direction, each furrowing nozzle being oriented to direct a respective high pressure jet of fluid downwardly and inwardly towards the other furrowing nozzle of the nozzle assembly.

9. The implement according to claim 8 wherein there is provided a ground follower associated with each suspension member and arranged to follow a contour of the ground in which the furrowing devices are movable together with the respective ground followers relative to the frame and wherein the furrowing nozzles are oriented such that the high pressure jets of the furrowing nozzles of each nozzle assembly are arranged to intersect one another at a location spaced below the ground follower corresponding to a bottom of the respective furrow.

10. The implement according to claim 1 wherein each nozzle assembly comprises a lead nozzle oriented to direct a respective high pressure jet of fluid downwardly and forwardly into the forward working direction.

11. The implement according to claim 10 wherein each nozzle assembly further comprises at least one furrowing nozzle oriented to direct a respective high pressure jet downwardly towards the ground and rearwardly of the high pressure jet from the lead nozzle such that said at least one furrowing nozzle is arranged to form the respective furrow in the ground.

12. The implement according to claim 1 wherein there is provided an upright guard member supported on a respective one of the suspension members forwardly of each furrowing device.

13. The implement according to claim 12 wherein the guard member extends downwardly towards the ground to a bottom end positioned lower in elevation than the respective furrowing device.

14. The implement according to claim 12 wherein the nozzle assembly of each furrowing device is supported for adjustment in height relative to the respective guard member.

15. The implement according to claim 1 wherein there is provided a pair of furrow closing members associated with each furrowing device, the furrow closing members being spaced apart in a lateral direction oriented transversely to the forward working direction on opposing sides of the respective nozzle assembly and extending rearward and inwardly towards one another to respective trailing ends positioned rearwardly of the respective nozzle assembly.

16. The implement according to claim 15 wherein there is provided a packer wheel supported rearwardly of the trailing ends of the respective pair of furrow closing members.

17. The implement according to claim 1 wherein the frame comprises an agricultural drawbar arranged for towing connection to a tractor and wherein each furrowing device is releasably supported on the drawbar.

18. The implement according to claim 1 wherein there is provided a residue manager device supported forwardly of each furrowing device, the residue manager device being arranged to clear loose material above the ground in front of the respective furrowing device.

19. An agricultural seeding implement comprising:
a frame supported for movement across the ground in a forward working direction;
a plurality of furrowing devices supported on the frame for movement together with the frame in the forward working direction, each furrowing device comprising a fluid nozzle assembly;
a source of liquid arranged to be associated with the frame for movement together with the frame in the forward working direction;
a pressurizing system arranged to provide a flow of fluid under pressure from the source of liquid to each of the fluid nozzle assemblies;
each fluid nozzle assembly comprising two furrowing nozzles oriented to direct the respective flow of fluid under pressure from the pressurizing system downwardly towards the ground such that the two furrowing nozzles are arranged to commonly form a furrow in the ground associated with said fluid nozzle assembly;
a seed supply associated with the frame for movement together with the frame in the forward working direction;
a seed tube supported rearwardly of each furrowing device so as to be arranged to deposit seed in the furrow formed by the furrowing device; and
a seed deliver system arranged to deliver seed from the seed supply to each of the seed tubes.

20. The implement according to claim 19 wherein the two furrowing nozzles of each nozzle assembly are spaced apart from one another in a lateral direction oriented transversely to the forward working direction, each furrowing nozzle being oriented to direct a respective high pressure jet of fluid downwardly and inwardly towards the other furrowing nozzle of the nozzle assembly.

21. The implement according to claim 20 wherein there is provided a suspension member supporting each furrowing device on the frame and a ground follower associated with each suspension member which is arranged to follow a contour of the ground, the furrowing devices being movable together with the respective ground followers relative to the frame, and wherein the furrowing nozzles are oriented such that the high pressure jets of the furrowing nozzles of each nozzle assembly are arranged to intersect one another at a location spaced below the ground follower corresponding to a bottom of the respective furrow.

22. The implement according to claim 19 wherein each nozzle assembly comprises a lead nozzle oriented to direct a respective high pressure jet of fluid downwardly and forwardly into the forward working direction ahead of the two furrowing nozzles of the nozzle assembly.
